(19) United States
(12) Patent Application Publication
(10) Pub. No.: US 2023/0088169 A1
(43) Pub. Date: Mar. 23, 2023

(54) System and methods for aiming and guiding interceptor UAV

(71) Applicant: Noam Kenig, Vancouver (CA)

(72) Inventor: Noam Kenig, Vancouver (CA)

(21) Appl. No.: 17/521,719

(22) Filed: Nov. 8, 2021

Related U.S. Application Data
(60) Provisional application No. 63/111,048, filed on Nov. 8, 2020.

(51) Int. Cl. B64U 10/14; B64U 70/10; B64U 70/90; B64U 20/87

(52) U.S. Cl. CPC B64U 10/14; B64U 70/10; B64U 70/90; B64U 20/87; B64U 2201/20; B64U 2101/16

(57) ABSTRACT

Disclosed are a system and method for aiming and/or guiding an interceptor Unmanned Aerial Vehicle to eliminate target Unmanned Aerial Vehicle, by holding the interceptor UAV to the direction of the target or by the use of a portable computer such as a table combined with the computer onboard camera and internal sensor to aim and guide the interceptor UAV toward the aerial threat by the operator. The UAV has a propulsion subsystem, imaging subsystem, flight sensors, and a computer processor that determine an intercept course for the UAV to the target using the sensors and the disable the target.

### RELATED APPLICATIONS

This Application claims Priority from Provisional Patent Application U.S. 63/111,048 filed 8 Nov. 2020.

### BACKGROUND OF THE INVENTION

Aerial platforms, such as Unmanned Air Vehicles (UAV), also known as drones, are not just available to the military anymore but can be purchased at every big-box store for commercial or personal use. As the use of drones rapidly increases, so too does the prevalence of hostile drone usage. Multiple aerial platforms exist, such as but not limited to multirotor and fixed-wing drone platforms have also been used in a wide variety of capacities to attack. Some tasks include destroying, disabling, burning, or otherwise damaging a target in the air or on the ground. Accordingly, a need has arisen for methods of attacking such aerial threats to avoid damage to military and/or civilian fields or installations. The present disclosure is directed to describe an aiming and guiding assist methods for attacking target Unmanned Aerial Vehicle Using an Unmanned Aerial Vehicle interceptor.

### SUMMARY OF THE INVENTION

The present disclosure is directed generally to aiming and or guiding interceptor UAV methods for countering threatening aerial platforms such as, but not limited to, Unmanned Air Vehicles (UAV).

According to one aspect of the invention there is an aerial Intercept System comprising: an unmanned aerial vehicle (UAV) having a propulsion subsystem, target detection subsystem, flight sensors, and a computer processor. The processor is arranged to: a) receive initial location data of an aerial target; b) determine a relative displacement vector to the target using the imaging subsystem; c) determine an intercept course for the UAV to the target using the relative displacement vector; d) control the propulsion subsystem along the determined intercept course; e) repeat steps b, c, and d until the UAV is within a predefined distance of the target and then disable the target by colliding with it or deploying a disablement subsystem.

The flight sensors may comprise at least one of: a GPS, a barometer, a gyroscope, an accelerometer, an electronic compass.

The disablement subsystem may comprise at least one of: a net, an explosive, a cutting device, or an electromagnetic jammer.

The UAV may comprise user-input means to initiate launch of the UAV and set the initial displacement data.

The system may comprise a portable electronic device having a processor, location and/or orientation sensors, user-input means, and a wireless transmitter for transmitting the initial location data and/or updated displacement data of the target to the UAV.

The portable electronic device may be one of: a smart phone, a tablet computer, and a pointer.

The portable electronic device may be arranged to: identify the target using a camera of said device; and wirelessly transmit a displacement of the target with respect to said device, wherein a location of said device is determined from the location sensors of said device.

According to another aspect of the invention there is a method of interception an aerial target comprising: identifying the aerial target; launching an unmanned aerial vehicle (UAV) towards the target; calculating an intercept course for the UAV towards the target using an onboard imaging subsystem and processor; propelling the UAV along the intercept course; and colliding with the target or deploying a disablement subsystem when the UAV is within a predetermined distance of the target.

The aerial target may be identified by machine vision using a portable electronic device

### BRIEF DESCRIPTION OF THE DRAWINGS

The invention may be described by the following drawings of preferred embodiment in which:

FIG. 1 is an overall schematic illustration of the configuration of an interceptor UAV system and associated methods.

FIG. 2A is an isometric view respectively of a representative interceptor UAV.

FIG. 2B is a plan view, respectively, of a representative interceptor UAV.

FIG. 2C is a front view respectively of a representative interceptor UAV.

FIG. 3A illustrates a hand aiming and launching method of the interceptor UAV.

FIG. 3B illustrates a interceptor UAV launched from a mechanical gimbal aiming device.

FIG. 4 illustrates the use of a portable tablet with a camera to aim and guide the interceptor UAV.

FIG. 5A illustrates the tablet user interface target selection.

FIG. 5B illustrates the tablet user interface target selection with manual or automated tracker.

FIG. 6 illustrates the use of an optical and or digital zoom.

FIG. 7 illustrates the interceptor UAV flight path guided by tablets.

FIG. 8 illustrates the interceptor UAV flight path guided by multiple tablets.

FIG. 9A illustrates a stand-alone interceptor and stand-alone pointer.

FIG. 9B illustrates an interceptor pointer attached to a weapon.

FIG. 10 is a flowchart for intercepting a target.

FIG. 11 is a flowchart for aiming an interceptor manually by hand or gimbaled.

FIG. 12 is a flowchart for aiming the intercepted to the target by tablet.

FIG. 13 is a flowchart for aiming the interceptor to the target by multiple tablets.

FIG. 14 is a flowchart for aiming the interceptor to the target by detection system.

### DETAILED DESCRIPTION OF THE INVENTION

The present disclosure is directed generally to a system and methods for aiming and/or guiding interceptor UAV to counter the aerial threat and associated methods. In particular, embodiments, representative a handheld method and using mobile assisting ground control to aim the interceptor UAV and provide guidance to the interceptor UAV toward the aerial threat and disabling it using kinetic impact or by deploying or using disabling mechanism onboard the interceptor UAV.

A representative aiming and/or guiding counter aerial interceptor methods and system in accordance with a particular embodiment includes an interceptor UAV that is launched toward an aerial target and aimed before take-off in the direction of the target by, for example, by launching it from hand or mechanical gimbal pointing to the target area until the onboard interceptor detection and guiding system detect the target and fly toward the target direction. This provides initial location data for the target. A hand launcher may be used to hold the UAV while providing a comfortable and safe way to hold in a user's hand. Thus the launcher's propulsion does not injure the user.

Another method includes the aiming and or guiding of the interceptor UAV toward the direction of an aerial target using a portable computer such as a portable tablet computer while combining the tablet onboard camera with its built-in sensors such as GPS and IMU to point and guide to the direction of the aerial target while updating the interceptor UAV for any changes in the target direction using wireless communication.

The interceptor UAV then flies autonomously to intercept the aerial target and disable it by directly colliding with (i.e. kinetically impacting) the target or using an onboard disabling mechanism to disable the target.

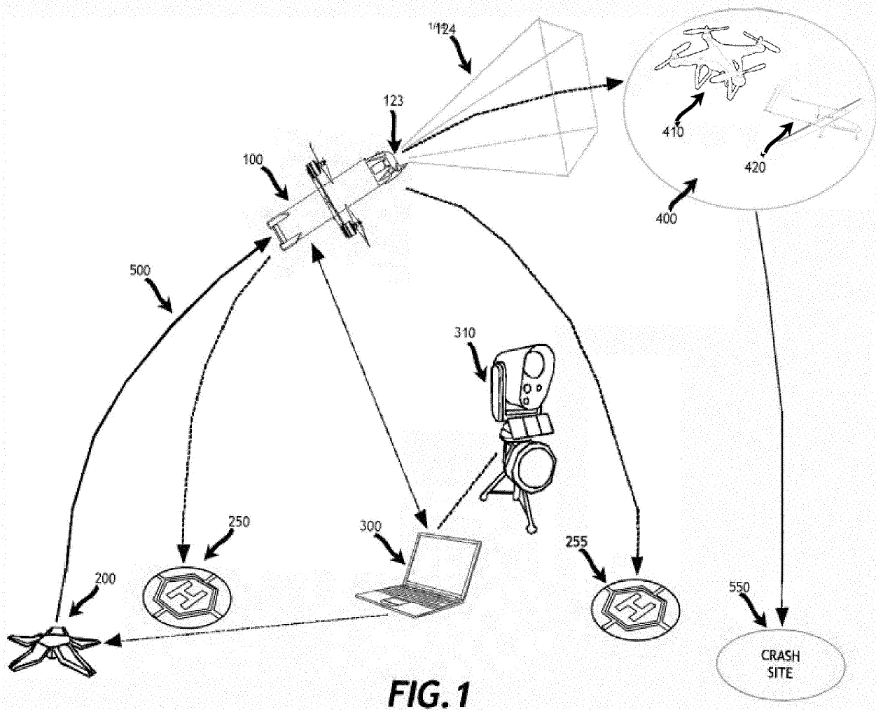

FIG. 1 illustrates an overall system in a self-guided configuration, namely, without the need of some ground-based detection and/or guiding system. The system includes an interceptor UAV 100 configured to disable or destroy an aerial target(s) 400, such as drones 410, kites 420, and balloons 430. The interceptor UAV 100 may include a ground station 300 (e.g., computer-based or controlled), with wireless communication to the interceptor UAV 100. The interceptor UAV 100 has flight sensors and a target detection subsystem 123 that is carried by the interceptor UAV 100 to autonomously detect and track the aerial target(s) 400 in its field of view 124. The launching pod 200 then launches the interceptor UAV 100, or the interceptor UAV 100 simply takes off from it based on commands from the ground station 300. The interceptor UAV 100 then flies toward 500 the aerial target(s) 400 until it intercepts and disables the aerial target(s) 400 by impacting the target(s) with or without an added penetrating/cutting device 125 or by triggering its internal explosive payload 126 once the interceptor UAV 100 gets closer to the aerial target(s) 400. The interceptor UAV 100 may communicate with ground station 300 using a wireless communication system that provides command and control signals and/or receives data from the interceptor UAV 100.

The target detection subsystem may be one of: optical imaging, infrared imaging, radar, Lidar, and ultrasound using the respective sensors and sensor processor algorithms. For example a optical camera may use existing machine vision techniques to detect a target visually.

The interceptor UAV 100 can fly back to the home base/launching pod 200 area to a designated landing pad 250, or it can land in designated landing pad 255 areas in close proximity to the aerial target(s) 400 when the electrical energy storage device is low and/or when the flight duration doesn't allow enough time for the interceptor UAV to return to the designated landing pad 250 in the home base area. In case of successful elimination of the aerial target(s) 400, the target's debris, that may include the interceptor UAV 100, will fall on the ground in a crash site 550 that may be predicted by the ground station 300 by calculating the interceptor UAV 100 and aerial target(s) 400 flight trajectory and impact location.

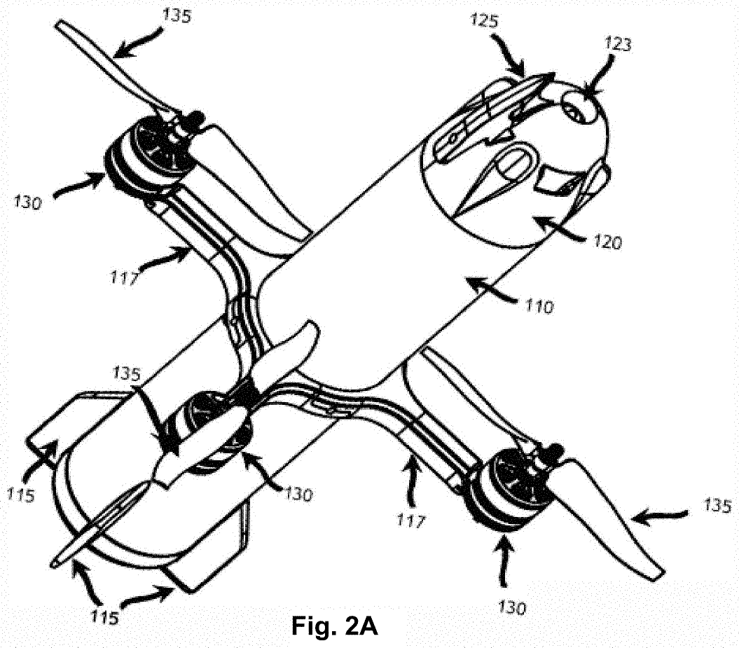

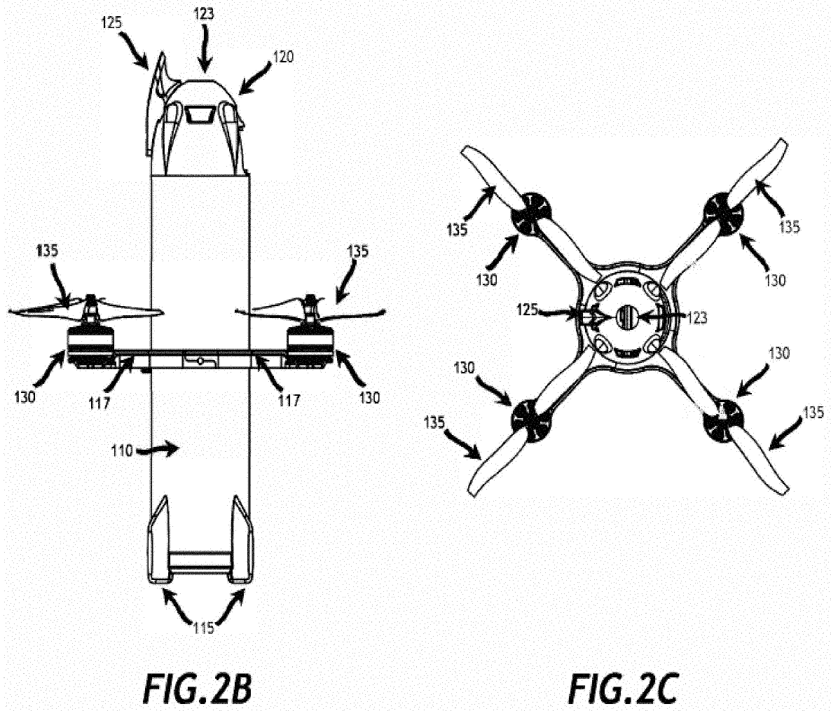

FIGS. 2A-2C are partially schematic, partially transparent views of a representative interceptor UAV 100 described above with reference to FIGS. 1. In a particular aspect of this embodiment, the interceptor UAV 100 includes a flight vehicle having fuselage 110, propulsion systems 130 and propellers 135 that provide thrust for the interceptor UAV 100.

In a particular aspect of an embodiment shown in FIGS. 1, the propellers 135 can be integrated with holding arms 117 into the fuselage 110 at some distance along the length of the fuselage 110. The interceptor UAV 100 can include one or more fins 115 (e.g., four) that provide stability for the interceptor UAV 100.

The propulsion system 130 can further include a power source 140 that provides power to the propellers 135. In a particular embodiment, the power source 140 includes an electrical energy storage device, for example, one or more batteries.

The interceptor UAV 100 can also include a vehicle management system 142 that oversees, conducts, directs, and/or executes processes, at least some of which are carried out by a variety of systems, subsystems and/or other elements.

Representative systems include a guidance system 141 that operates to control and guide the interceptor UAV 100 toward its target. For example, the guidance system 141 can be coupled to propulsion system 130 to steer and maneuver the interceptor UAV 100. The guidance system 141 can also include a navigation system (e.g., an onboard GPS system) that provides information regarding the location of the interceptor UAV 100.

Representative systems include an image-based processing system that can run on the vehicle management system 142 to process real-time images from the forward-looking camera 123 to detect the aerial target(s) and control and guide the interceptor UAV 100 toward the target(s) until the disabling of the target(s) is achieved.

The interceptor UAV 100 can also include a disabling subsystem, such as a penetrating/cutting device 125, electromagnetic jammer, net or an explosive payload 126 that is designed to engage with the aerial target(s) 400 described above with reference to FIGS. 1-2. The explosive payload disabling system 126 is automatically triggered when the interceptor UAV 100 is within a predefined proximity of the aerial target(s) 400 and/or while impacting the aerial target(s) 400. The disabling penetrating/cutting device 125 helps increase the impact damage to the aerial target(s), which may help physically protect the interceptor UAV 100.

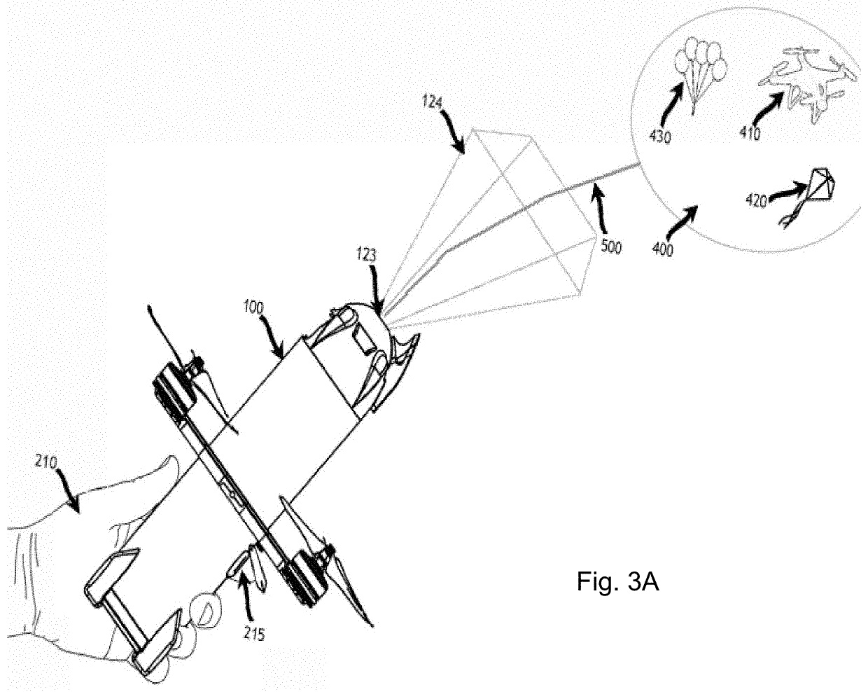

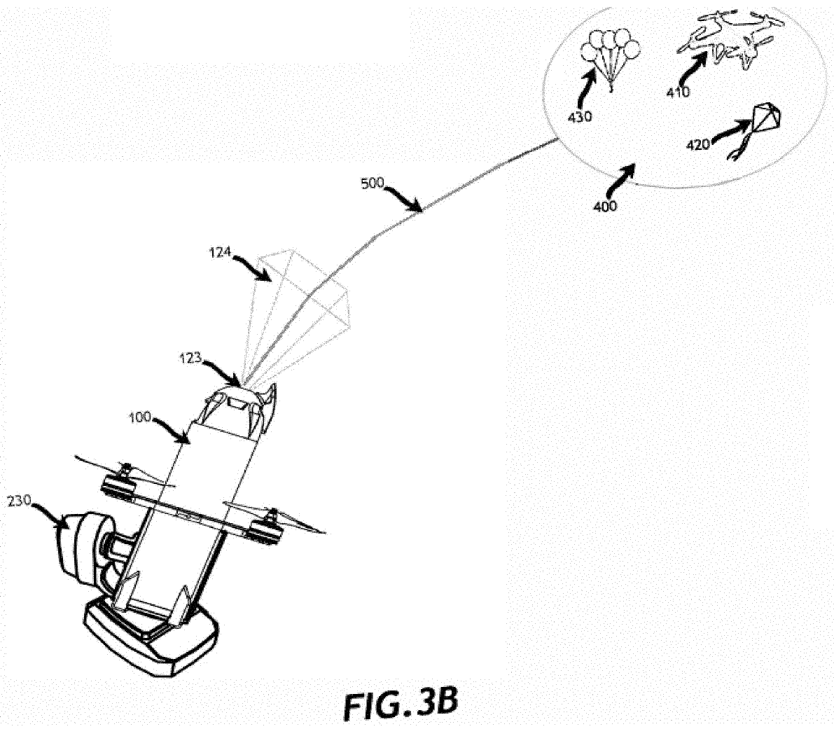

FIGS. 3A-3B represent different setups and launching configurations of the interceptor UAV 100 with or without the use of a ground station 300 or target acquisition system 310.

FIG. 3A illustrates a hand-launching 210 configuration of the interceptor UAV 100 aimed toward the aerial target(s) 400. The interceptor UAV 100 is held by the operator and aimed at the aerial target direction. The operator activates the interceptor UAV 100 by pressing a button 215 on the interceptor UAV 100 or by another device such as a ground station 300 (see FIG. 1). The interceptor UAV 100 takes off while keeping the operator's flying direction until the internal target acquisition system 123 of the interceptor UAV 100 detects the aerial target(s) 400 in its field of view 124. The interceptor UAV 100 adjusts its flight trajectory 500 to intercept and disable the aerial target(s) 400 by impacting the target(s) with or without an added penetrating/cutting device 125 (see FIG. 3) or by triggering its internal explosive payload 126 (see FIG. 3) once the interceptor UAV 100 gets closer to the aerial target(s) 400. In case of unsuccessful engagement with the aerial target(s) 400, the interceptor UAV 100 may retry finding and engaging with the aerial target(s) 400. Otherwise, it lands in a designated area such as the take-off area, unless it does not survive the attacking operation.

FIG. 3B illustrates a ground mechanical gimbal 230 setup of the interceptor UAV 100. This gimbal is used as an aiming device 230 that can pan and tilt the interceptor UAV 100 toward the aerial target(s) 400. The interceptor UAV 100 is aimed at the target area and activated remotely by a ground station 300 (see FIGS. 1 and 2) or autonomously by the internal target acquisition system 123 of the interceptor UAV 100. The interceptor UAV 100 takes off while maintaining the aimed flight direction until the interceptor UAV's 100 target acquisition system 123 detects the aerial target(s) 400 in its field of view 124. The interceptor UAV 100 adjusts its flight trajectory 500 to intercept and disable the aerial target(s) 400 by impacting the target(s) with or without an added penetrating/cutting device 125 (see FIG. 3) or by triggering its internal explosive payload 126 (see FIG. 3) once the interceptor UAV 100 gets closer to the aerial target(s) 400. In case of unsuccessful engagement with the aerial target(s) 400, the interceptor UAV 100 may retry finding and engaging with the aerial target(s) 400. Otherwise, it lands in a designated area such as the take-off area, unless it doesn't survive the attacking operation.

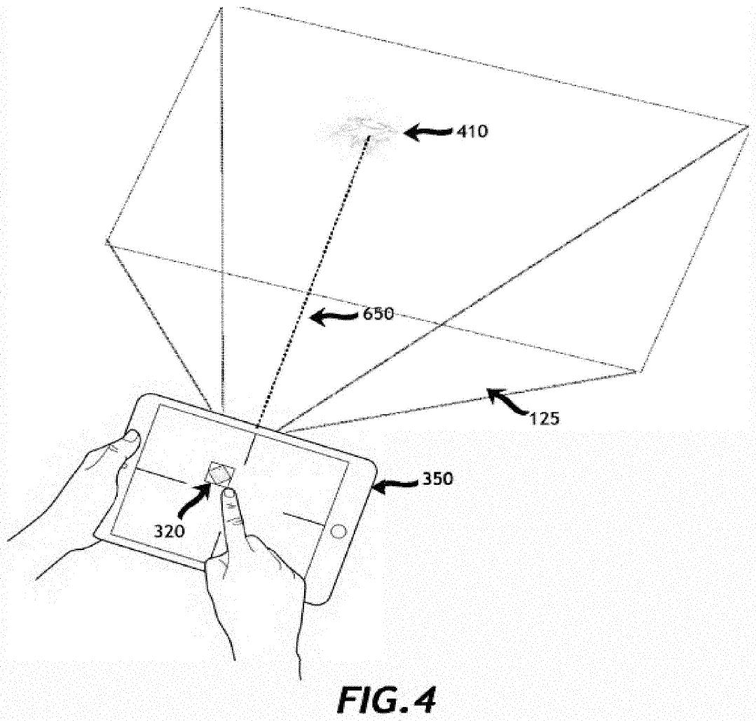

FIG. 4 illustrates the use of a portable electronic device 350, such as a mobile phone or tablet with a camera to aim and guide the interceptor UAV to the target 410. The portable electronics device 350 uses its internal sensors, such as GPS, compass, barometer, and IMU together to compute the direction and distance 650 of the target 410 that is selected in the user interface 320 and that is visible in the field of view 125.

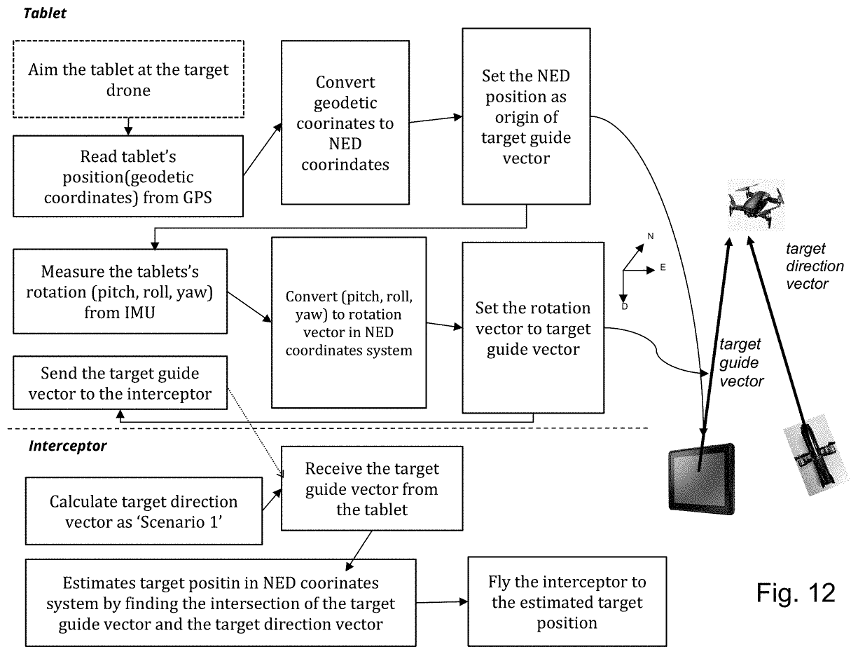

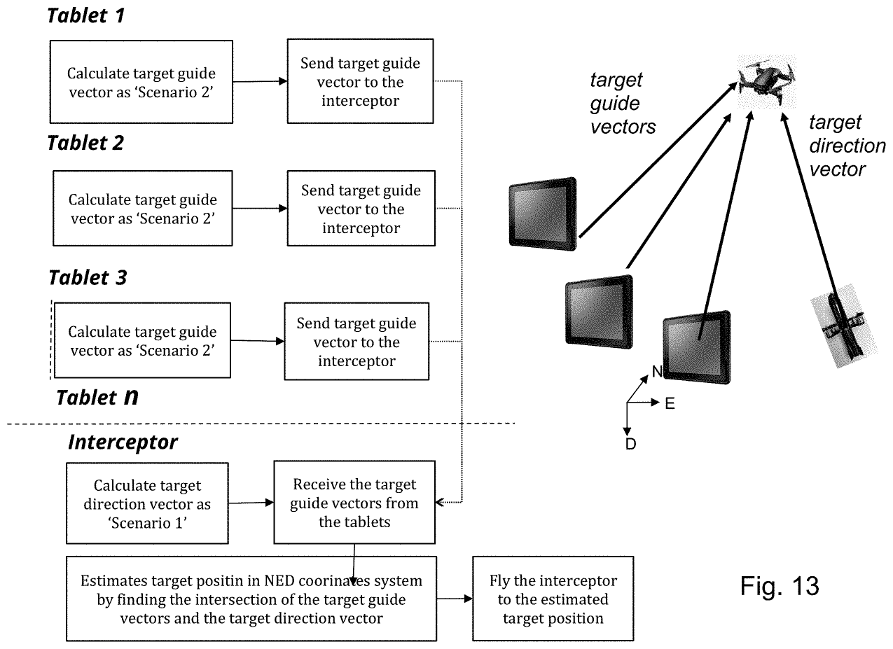

The computed target position is wirelessly transferred to the interceptor UAV 100 to calculate the flight path to detect and intercept the target 410. FIG. 12 illustrates the logic for calculating a target direction vector using a tablet. FIG. 13 illustrates the logic for plural tablets.

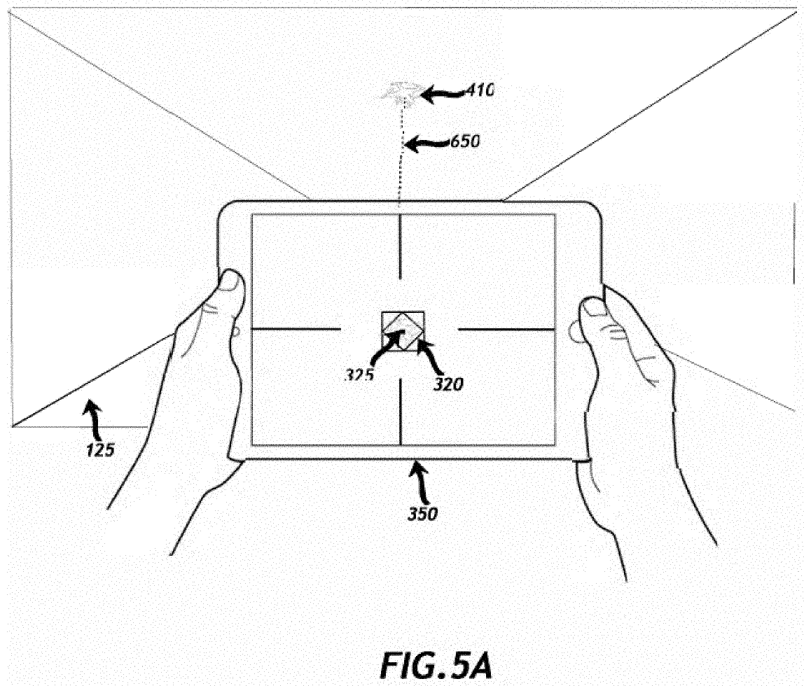

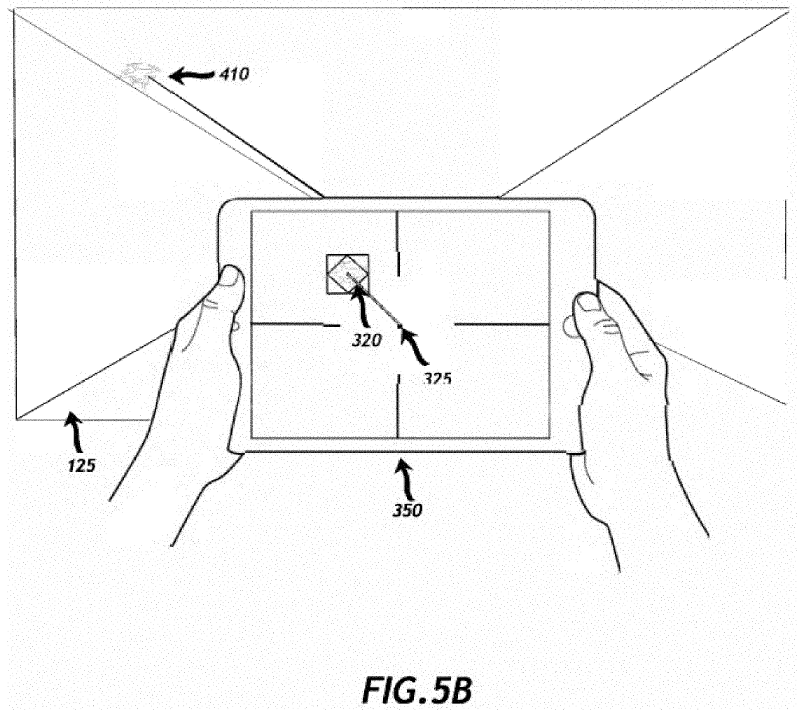

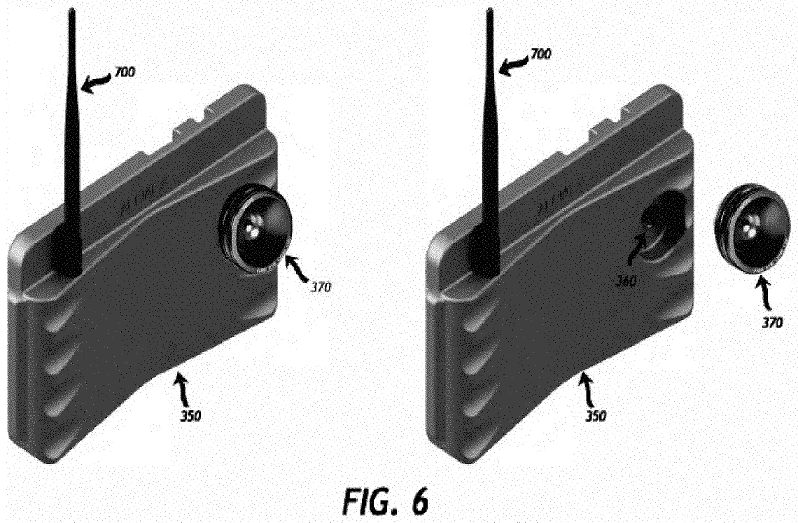

FIG. 5A illustrates the portable ground control station's 350 user interface for target selection, while positioning the selected target in the center of the portable ground control's display to calculate the target 410 positions and direction 650 in the field of view 125.

FIG. 5B illustrates a targeting approach, similar to FIG. 5A. But in this approach, the portable ground control station 350 can track the target position that could be away from the center 325 of the ground control station 350 fields of view 125 by running machine vision and or artificial intelligence algorithms to calculate the position and distance 650 of the target 410.

FIG. 6 illustrates the optional use of the attached optical zoom lens 370 to increase effectiveness and the range of the ground control station 350 with or without digital zoom. The zoom lens can be attached directly into the ground control station 350 body to special attachment configuration 360. The ground control station 350 can also have an optional long-range communication modem with antenna 700 to communicate directly to the interceptor 100 or other communication devices.

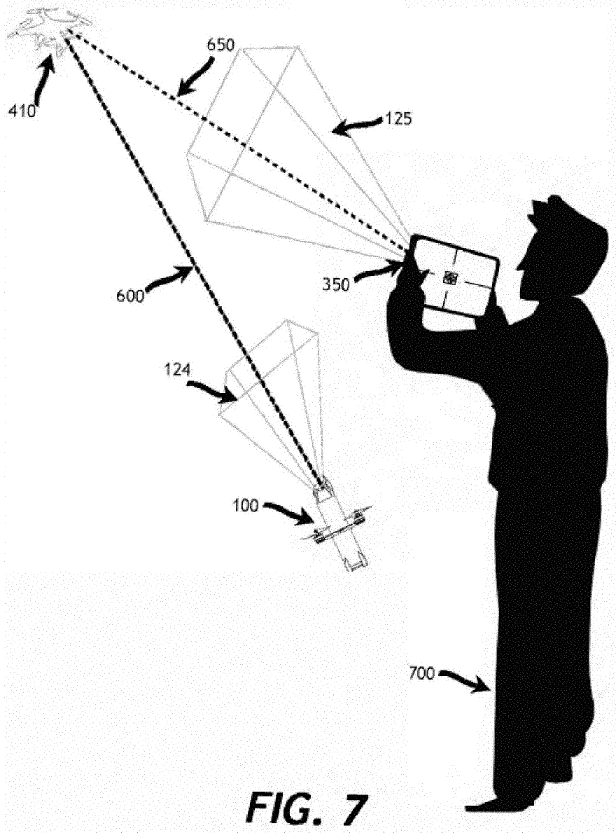

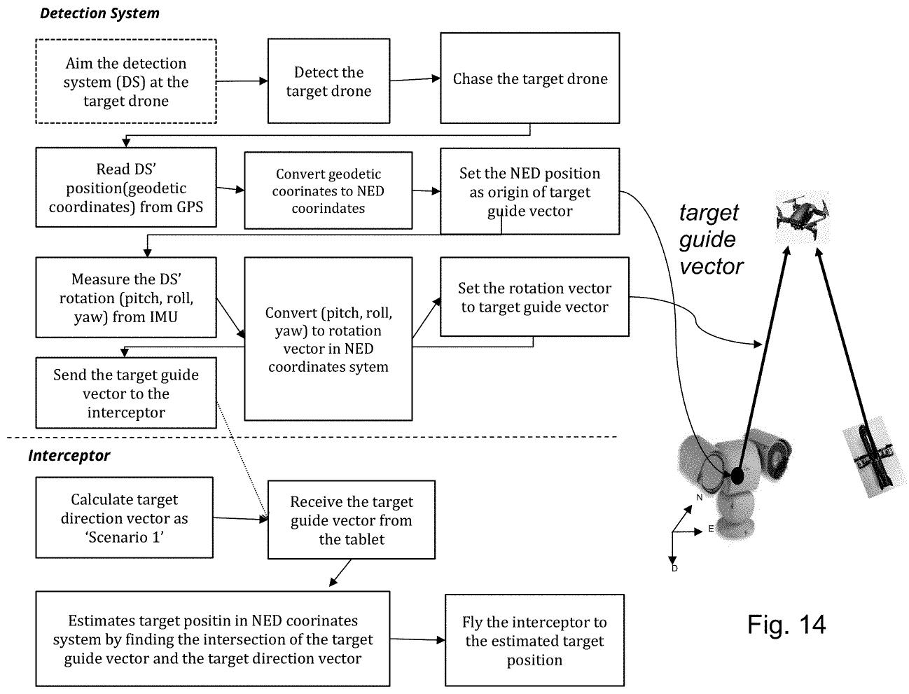

FIG. 7 illustrates the use of the ground control station 350 to guide the interceptor UAV 100 flight path to intercept the target 410. The operator 700 visually detects the target 410 and uses the ground control station 350 by aiming the ground control station 350 to the target 410 and selecting the target in the ground control station 350 user interface by centring the target, selecting the target, or by the use of computer vision to detect, classify and track the target inside the field of view 125. At the same time, the ground control station 350 sends the target position and estimated distance 650 to the interceptor UAV 100 that flies toward 600 the target 410 until entering into the interceptor field of view 124 to initiate an attack on the target 410. The operator 700 can mark the target position once and send it to the interceptor UAV 100 or keep pointing the ground control station 350 to the target position to keep updating the interceptor UAV 100 of the target 410 positions. FIG. 14 provides the logic for detecting the target and calculating a target guide vector.

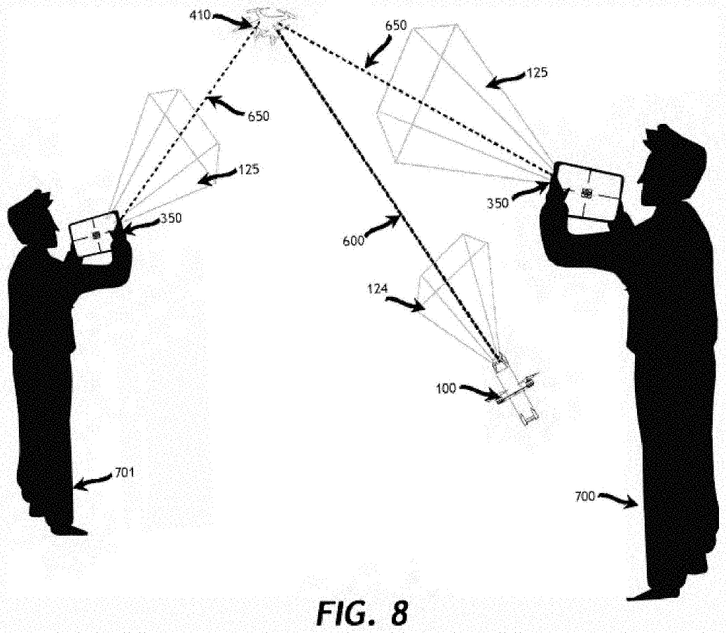

FIG. 8 illustrates a similar mode of operation to FIG. 7 but with the added input from another operator 701, which helps to triangulate the target position more accurately by combining the information that comes from plural spaced-apart sources sent wirelessly to the interceptor UAV 100 to calculate a more precise flight path toward 600 the target 410

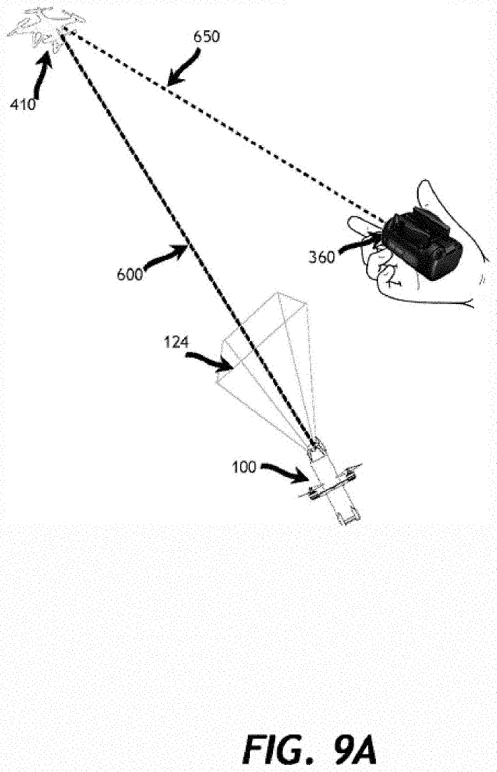

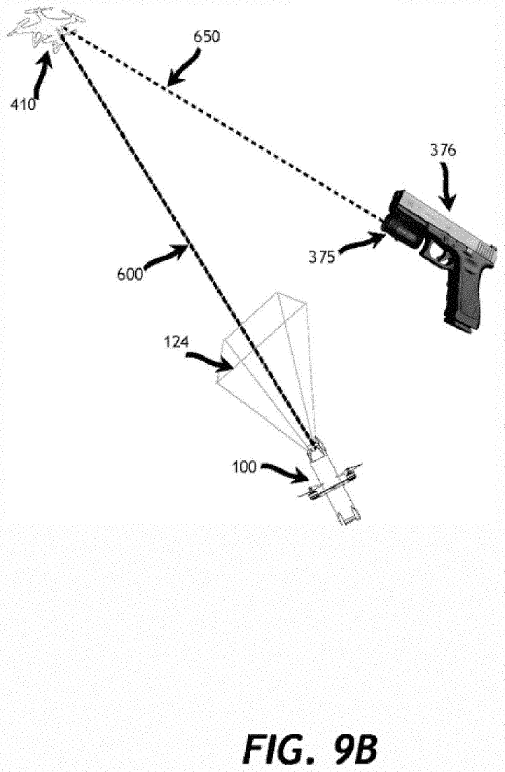

FIG. 9A illustrates the use of a standalone pointer 360 with a build in positioning sensor, such as GPS and IMU to calculate the intercept angle toward the target and transmits this to the UAV100 . This sensor can work as a standalone device with orientation and positions sensors, which sensor data are transmitted wirelessly to the UAV. Thus it need not have a camera or image processor, but an aiming marking or sight can help the user point it in the right direction. The standalone pointer 360 may have a user-input means, such as a switch or button, to help the user adjust the flight path of the UAV 100 toward 600 the targets 410.

FIG. 9B illustrates the use of a standalone interceptor pointer 375 attached to weapon 376 with a build-in positioning sensor such as GPS and IMU that calculate and transmit to the interceptor 100 the direction angle 650 to the target 410. This sensor can work as a standalone and does not need a table or imaging device such as a camera but to aim the weapon to the direction in the right direction. The standalone pointer 360 could also have a button to help the user adjust the flight path of the interceptor 100 toward 600 the targets 410.

The system may be capable of multiple modes for intercepting to disable the target. A preferred mode, “AIM mode” allows the Interceptor to attack aerial targets that are visible to an operator from the ground.

The mode does not necessarily rely on a detection system to give the target position (e.g. radar), rather it will only use updates from the operator who can provide an estimated target direction by aiming a device toward the target. During the approach, the Interceptor will be assisted by continuous target direction updates until it achieves a visual lock using its own onboard computer vision system and can complete the attack.

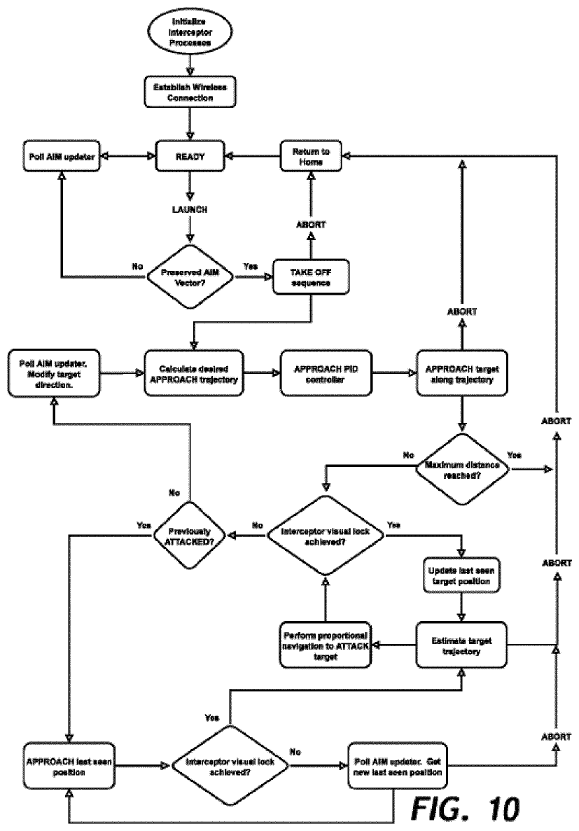

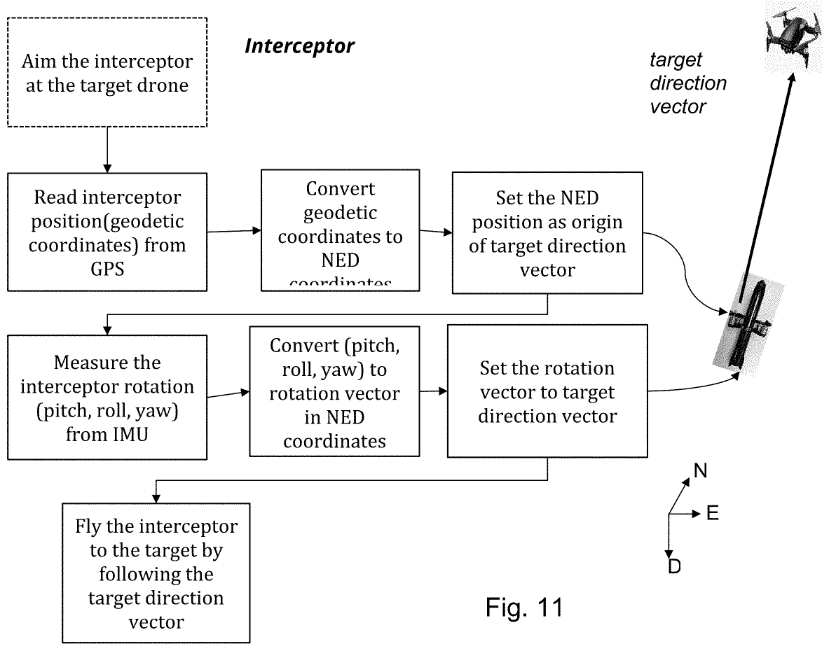

The operator provides an initial target direction (AIM direction) prior to launch, which direction is towards the target along the axis of launch propulsion. FIG. 10 provides a flowchart for AIM mode. In the embodiment shown in the drawings, the propellers initially launch the UAV along the major axis of the UAV and the target is within the field of field of the onboard camera in that launch direction. Once launched, the UAV will complete its take-off sequence to gain altitude and will then begin to approach along the approach trajectory, which is calculated based on the initial direction. An approach control loop is performed to ensure the UAV flies precisely along this trajectory without straying. The location data (aka AIM direction or displacement vector) to target can be modified in real-time by polling updates sent by the operator. However, the UAV can still complete its mission in the event of communication loss by using the most recent AIM direction. If the UAV does not gain a visual lock, it may time-out and enter Return to Home (RTH) mode, and fly back to the original launch point.

Additionally, the operator can send the ABORT command at any time to force RTH.

Once the Interceptor achieves a visual lock, it will begin the attack. The estimated target position and trajectory, closing speed, and change in the target line of sight angles are calculated. These values are used by a proportional navigation algorithm that generates the required lateral thrust in order to intercept any moving or stationary target. The thrust requirements are translated to movement commands and sent to the motors to complete the attack.

During any time that a visual lock is present, the Interceptor's own position is saved, representing the “last seen target position”. This serves as a retry method when losing sight of the target. This position can be interpolated using the estimated target velocity in the case of a moving target. If the target still cannot be found, it will continue to poll for updates from the operator on the ground. These updates will modify the “last seen target position”, and will allow the Interceptor to get in position again to gain sight of the target and complete another attack.

Location data may be a) a relative (Δx, Δy, Δz) or global position (latitude, longitude, altitude) in three-dimensional coordinates b) an orientation or direction in angular coordinates. Location data and intercept courses may be expressed as displacement vectors of distance in a direction. The fullness of the location specification depends on what sensors are used and the confidence in their readings. For example, the initial location data may provide a general relative direction with an estimated distance. Advantageously, the intercept course determined by the onboard sensors may be more precise and are updated more frequently.

1. An Aerial Intercept System comprising:
an unmanned aerial vehicle (UAV) having a propulsion subsystem, target detection subsystem, flight sensors, and a computer processor arranged to:
a) receive initial location data of an aerial target;
b) determine a relative displacement vector to the target using the detection subsystem;
c) determine an intercept course for the UAV to the target using the relative displacement vector;
d) control the propulsion subsystem along the determined intercept course;
e) repeat steps b, c, and d until the UAV is within a predefined distance of the target and then disable the target by colliding with it or deploying a disablement subsystem.

2. The system of claim 1, wherein the flight sensors comprise at least one of: a GPS, a barometer, a gyroscope, an accelerometer, an electronic compass.

3. The system of claim 1, further comprising a gimbaled launch pad for the UAV.

4. The system of claim 1, wherein the disablement subsystem comprises at least one of: a net, an explosive, a cutting device, or an electromagnetic jammer.

5. The system of claim 1, wherein the UAV further comprising user-input means to initiate launch of the UAV and set the initial displacement data.

6. The system of claim 1, further comprising a portable electronic device having a processor, location and/or orientation sensors, user-input means, and a wireless transmitter for transmitting the initial location data and/or updated displacement data of the target to the UAV.

7. The system of claim 1, wherein the portable electronic device is one of: a smart phone, a tablet computer, and a pointing device.

8. The system of claim 1, further comprising a ground station detection system comprising sensors for detecting the target and communication means for relaying coordinates or intercept vector of the target to the UAV's computer processor.

9. The system of claim 6 wherein the portable electronic device is arranged to:
identify the target using a camera of said device; and
wirelessly transmit a displacement of the target with respect to said device, wherein a location of said device is determined from the location sensors of said device.

10. The system of claim 1, wherein the target detection subsystem is one of: optical imaging, infrared imaging, radar, Lidar, and ultrasound.

11. A method of interception an aerial target comprising:
a. identifying the aerial target;
b. launching an unmanned aerial vehicle (UAV) towards the target;
c. calculating an intercept course for the UAV towards the target using an onboard target detection subsystem and processor;
d. propelling the UAV along the intercept course; and
e. colliding with the target or deploying a disablement subsystem when the UAV is within a predetermined distance of the target.

12. The method of claim 11, wherein the UAV is launched by hand of a user in response to an input from the user.

13. The method of claim 11, wherein the aerial target is identified by machine vision using a portable electronic device

14. The method of claim 11, wherein the aerial target is identified by a hand-held pointer having location or orientation sensors.

15. The method of claim 11, wherein calculating the intercept course further comprises using onboard flight sensors selected from at least one of: a GPS, a barometer, a gyroscope, an accelerometer, an electronic compass.

16. The method of claim 11, wherein the disablement subsystem comprises at least one of: a net, an explosive, a cutting device, or an electromagnetic jammer.

17. The method of claim 11, further comprising wirelessly transmitting the initial location data and/or updated location data of the target to the UAV a portable electronic device having a processor, location and/or orientation sensors, user-input means, and a wireless transmitter for.

18. The method of claim 11, wherein the portable electronic device is one of: a smart phone, a tablet computer, and a pointer.

19. The method of claim 11, wherein the portable electronic device is arranged to:
identify the target using a camera of said device; and
wirelessly transmit a displacement of the target with respect to said device, wherein a location of said device is determined from the location sensors of said device.

20. The method of claim 11, wherein the target detection subsystem is one of: optical imaging, infrared imaging, radar, Lidar, and ultrasound.
